(19) United States
(12) Patent Application Publication
(10) Pub. No.: US 2004/0145900 A1
(43) Pub. Date: Jul. 29, 2004

(54) Laser type lights for the provision of visual cues for location of a vehicle on the roadway

(76) Inventor: John Matthew Camp, Houston, TX (US)

Correspondence Address: John Matthew Camp, 13018 Norstrum Falls Court, Houston, TX, 77429, US

(21) Appl. No.: 10/758,466

(22) Filed: Jan. 15, 2004

Related U.S. Application Data
(60) Provisional application No. 60/440,039, filed on Jan. 15, 2003.

(51) Int. Cl. B60Q 1/00

(52) U.S. Cl. 362/487

(57) ABSTRACT

The present invention provides a lighting system which has the primary purpose to provide the visual cues necessary to allow for the accurate determination and manual orientation of the track of a vehicle in relationship to objects which are adjacent to the path of travel. The invention herein described is comprised of one or more laser lights which are affixed to the forward portion of the vehicle in such as manner as to accurately indicate the point or points on the roadway which will be traversed by the tire or tires of the vehicle.

This application claims the benefit of U.S. provisional patent application 60/440,039, filed Jan. 15, 2003

### FIELD

The present invention pertains to lighting systems for motor vehicles; more particularly, lighting systems which provide visual cues which enable the driver to better locate the position of a motor vehicle on its travel path.

### BACKGROUND

The increase, in recent years, of automobile designs which are aerodynamically styled to increase fuel efficiency through the reduction of wind resistance and drag, has decreased the ability of the driver to accurately determine the position of his vehicle on the roadway through the loss of visual cues such as fenders, hood ornaments or, in many cases the visibility of any portion of the hood or other forward portions of the vehicle from the cockpit.

In addition, the aging population has increased the number of drivers who, by virtue of their age, have more difficulty in ascertaining the exact location of the track of their vehicle in relation to curbs, freeway dividers, unmarked highway lanes or other road hazards, or roadway situations in which the availability of visual cues as to the track of the vehicle would be helpful to the driver. This is particularly true in dark or late evening situations when visibility is at its natural worst and external visual cues are most difficult to obtain. . .

Accordingly, there is a need in the art for a lighting system which will assist the operator of a motor vehicle in ascertaining the exact location of the track of their vehicle in relation to objects on the travel path

### SUMMARY

The present invention provides a lighting system which assists the operator of a motor vehicle in ascertaining the exact location of the track of the motor vehicle in relation to objects on the travel path. The purpose of this invention is to provide the visual cues necessary to allow for the accurate determination and manual orientation of the track of a vehicle on the roadway, in relationship to objects, marked and unmarked lanes, hazards etc., and the relationship of the track of the vehicle to the roadside, curbs, barriers and the like which are adjacent to the path of travel.

The invention herein described is comprised of one or more laser type lights which are affixed to the forward portion of the vehicle such as the lid of the hood or other suitable location on the body, frame, bumpers, grille or other component of a vehicle, and oriented into a fixed position, downward, in such as fashion as to provide a spot or spots or strip or strips of laser light on the roadway, visible to the driver, a short distance in front of the automobile, such point(s) of light to be adjusted, oriented and fixed in such as manner as to accurately indicate the point or points on the roadway which will be traversed by the tire or tires of the vehicle if it continues in a straight line in the direction in which the vehicle is oriented, and such lights to be of a type and in positions and in such orientation, and to be fixed in such a manner as to not interfere with or endanger the vision of drivers of other vehicles.

the technology for small contained laser lights is well established The power source for the laser lights is to be the automobile battery or such other sources as are generated by a vehicle.

an embodiment of the invention would include the permanent installation of such lights into the automobile in a fixed manner in any such location that would provide the desired visual cues.

a further embodiment of the invention would include lights which may be activated by a separately installed electrical circuit or a circuit which may be incorporated into the wiring of the vehicle.

the invention can be used on, and will be applicable to all vehicles, of all sizes, both private and commercial. The invention will also be applicable in the use of smaller recreational vehicles during operational mode, and the invention will provide benefit to recreational users during loading and unloading of recreational vehicles from transport trailers. This application can be utilized for purpose of any vehicle required to track a specific pathway, (i.e. entering a repair facility work bay)

### BRIEF DESCRIPTION OF THE DRAWING FIGURES

A better understanding of the system, method, and apparatus of the present invention may be had by reference to the drawing figures, wherein:

FIG. 1 is a side elevational view of some motorized vehicle (5), in this application a conventional automobile, where the line of site of the operator (1) is plotted against the applied target line (2) of the light source

FIG. 2 is a plan view of the vehicle where again, the line of site of the operator (1) is plotted against the applied target line (2) of the light source (4).

FIG. 3 is an isometric depiction of one possible type of assembly including a mounting system (3) and the source of light (4)

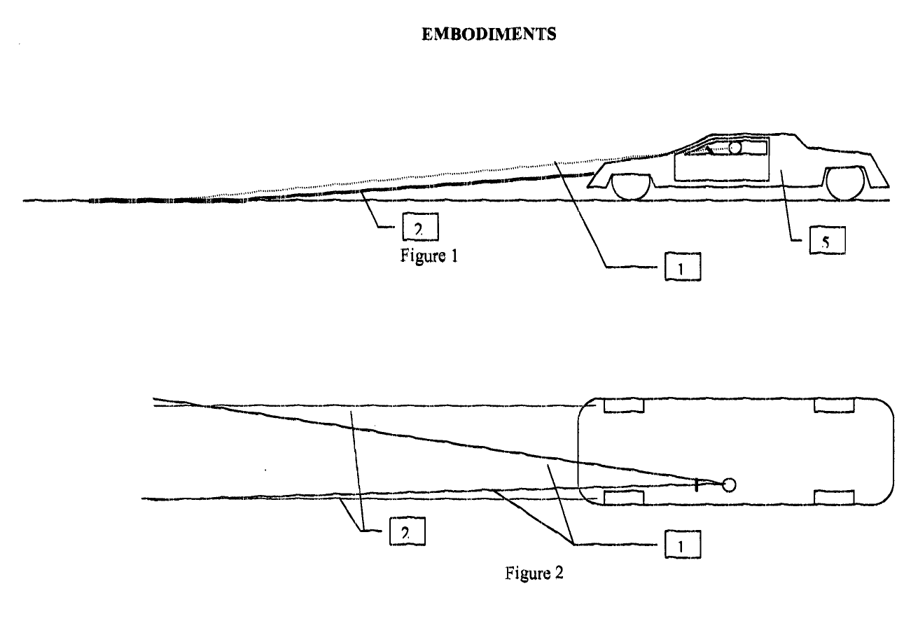

### DESCRIPTION OF THE EMBODIMENTS

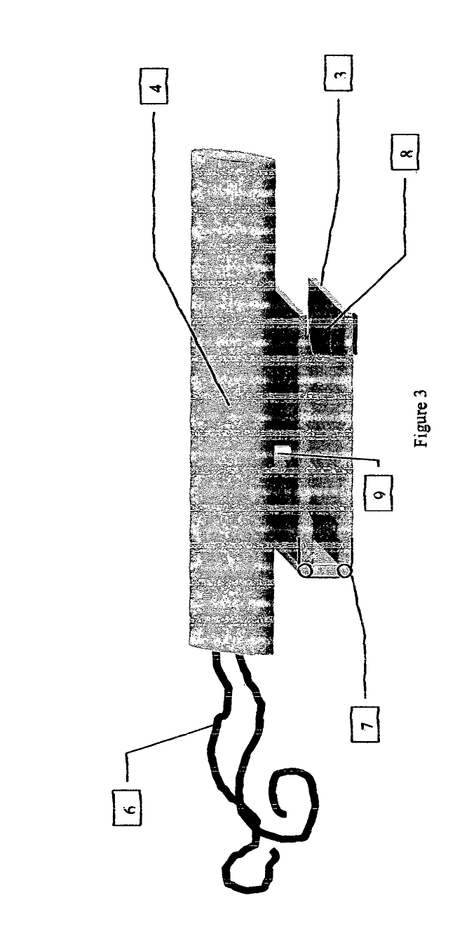

In the preferred embodiment, the mounting system (3) and light source (4) are provided to allow the owner/operator or automobile manufacturer to quickly and efficiently attach the entire assembly (FIG. 3) to the vehicle (5). The assembly (FIG. 3) is provided with wires (6) that are marked and can be easily wired into the vehicle (5) electrical system. In one possible embodiment, the wires may be directly clipped into the vehicle (5) night driving lights and operated by the power switch already provided inside of the vehicle (5).

Once the assembly (FIG. 3) is installed, the direction and desired path of the light source (4) can be adjusted along multiple axis as necessary to achieve the desired target line (2). Once installed, the operator may provide power to the light source (4) and will be provided a visual cue of the vehicles (5) projected path. The applied target line (2) emitted by the light source (4) will assist the operator in maintaining a more direct path and may assist in obstacle or hazard avoidance.

In the preferred embodiment, the assembly (FIG. 3) is provided with a double hinge clamp (7) that allows the mount to be placed on a variety of locations. The light source (4) is attached to the mounting system (3) which contains an adjustment point (9) with the ability to pivot on the X and Y axis, allowing the operator to effectively position the target line (2) of the light source (4), while also insuring that the target line (2) does not interfere with the vision of oncoming vehicles. A set screw (8) may be provided to lock the light source (4) and mounting system (3) into final position if necessary.

While the system, apparatus, and method have been described according to the preferred and alternate embodiments, those of ordinary skill in the art will understand that numerous other embodiments of the disclosed invention may be made. Such other embodiments shall be included within the scope and meaning of the appended claims.

What is claimed is:

1. A system of lighting for establishing visual cues indicating the potential progress path of a moving vehicle through the use of a high intensity light being emitted from a source located on said moving vehicle consisting of:
Means for mounting said system to vehicle;
Said means for mounting including attachment for source of lighting;

2. The system of claim 1 wherein said mounting means is capable of adjusting path of light, emitted from the source of lighting, along the X and Y axis, i.e. horizontal and vertical.

3. The system of claim 1 wherein the high intensity light beam is a laser.

4. The system of claim 1 wherein the power for source of lighting is provided by the vehicle in which said system is mounted to.

5. The system of claim 1 wherein the power for source of lighting is provided by a power source independent

6. The system of claim 1 wherein said visual cues are displayed on the travel surface of the vehicle, indicative of the travel path of the vehicle wheels

7. The system of claim 1 where in said visual cues are provided as a line

8. The system of claim 1 wherein said visual cues are provided as a point or spot.

9. The system of claim 1 wherein a plurality of said sources of lighting is utilized to provided multiple visual cues.

10. The system of claim 1 wherein the emitted light from said lighting source providing said visual cues, is undetectable by operators of approaching vehicles.

11. A method of providing visual cues indicating the potential progress path of a moving vehicle wherein a high intensity light is emitted from source located on said moving vehicle which consists of;
Means of mounting said lighting source
Means of adjusting said lighting source to so that said emitted light is directed to a location indicating the future path of the said moving vehicle.

12. The method of claim 10 wherein the source of lighting is a laser.

13. The method of claim 10 whereby the operator manually engages or disengages said source of lighting

14. The method of claim 10 whereby the source of lighting is engaged at anytime during use of said moving vehicle.
